(19) United States
(12) Patent Application Publication
(10) Pub. No.: US 2014/0307220 A1
(43) Pub. Date: Oct. 16, 2014

(54) LENS DEVICE, FRAME, TEMPLE AND MANUFACTURING METHOD THEREOF

(71) Applicant: HWA MEEI OPTICAL CO., LTD., Tainan City (TW)

(72) Inventor: CHIH MING CHEN, TAINAN CITY (TW)

(21) Appl. No.: 13/921,330

(22) Filed: Jun. 19, 2013

(30) Foreign Application Priority Data
Apr. 10, 2013 (TW) 102112696

(51) Int. Cl. G02C 5/00

(52) U.S. Cl. CPC G02C 5/008
USPC 351/83; 351/111; 264/504

(57) ABSTRACT

A frame of a lens device includes a frame portion and at least a hollow portion which is disposed in the frame portion. A temple of a lens device is also disclosed, including a temple portion and at least a hollow portion disposed in the temple portion. A lens device is also disclosed, including the said frame or temple. The manufacturing methods of the said frame and temple are also disclosed.

### BACKGROUND OF THE INVENTION

1. Field of the Invention

The invention relates to a lens device and, in particular, to a lens device, a frame, a temple and manufacturing methods thereof.

2. Description of the Prior Art

The lens device, such as sunglasses, working goggles, nearsighted eyeglasses, farsighted spectacles, presbyopia eyeglasses or the like, have become an indispensable appliance, helping people's living a lot. However, there are still some inconveniences in usage although the eyeglasses industry has been developed to this day. For example, the eyeglasses are too heavy, so that the user getting used to wear eyeglasses is made sunken wings of the nose, which also affects the user's appearance.

Therefore, it is an important subject to provide a lens device that can be decreased in weight for enhancing the using efficiency and product competitiveness.

### SUMMARY OF THE INVENTION

In view of the foregoing subject, an objective of this invention is to provide a lens device, a frame, a temple and manufacturing methods thereof, wherein the weights thereof are decreased so that the using efficiency and product competitiveness can be enhanced a lot.

To achieve the above objective, a frame of a lens device according to this invention comprises a frame portion and at least a hollow portion disposed in the frame portion.

In one embodiment, the hollow portion causes the frame portion to have a wall thickness not less than 0.5 mm.

To achieve the above objective, a temple of a lens device according to this invention comprises a temple portion and at least a hollow portion disposed in the temple portion.

In one embodiment, the hollow portion causes the temple portion to have a wall thickness not less than 0.5 mm.

To achieve the above objective, a lens device according to this invention comprises any one of the frame as mentioned above and at least a lens which is fixed to the frame.

To achieve the above objective, a lens device according to this invention comprises a frame and two temples as mentioned above which are respectively disposed to the opposite sides of the frame, and at least a lens fixed to the frame.

To achieve the above objective, a manufacturing method of a frame of a lens device according to this invention comprises steps of: forming a frame; and supplying a gas during the formation of the frame to generate at least a hollow portion in the frame.

To achieve the above objective, a manufacturing method of a temple of a lens device according to this invention comprises steps of: forming a temple; and supplying a gas during the formation of the temple to generate at least a hollow portion in the temple.

To achieve the above objective, a manufacturing method of a frame of a lens device according to this invention comprises steps of: forming a frame; supplying a liquid during the formation of the frame; and removing the liquid to generate at least a hollow portion in the frame.

To achieve the above objective, a manufacturing method of a temple of a lens device according to this invention comprises steps of: forming a temple; supplying a liquid during the formation of the temple; and removing the liquid to generate at least a hollow portion in the temple.

As mentioned above, at least a hollow portion is formed in the frame and/or temple of the lens device of the invention by several methods, so the frame and temple can be decreased in weight while maintaining sufficient structural strength. Therefore, the user getting used to wear eyeglasses can take less pressure at the wings of the nose, and thereby the using efficiency and product competitiveness can be enhanced a lot. Besides, since the lens device, frame and temple of the invention is lighter, their densities can be controlled as less than 1, i.e. the density of water. Therefore, when the user doing aquatic sports loses the eyeglasses, the user can easily find them. Furthermore, since the lens device, frame and temple of the invention consume less material, the environmental protection can be effectively achieved. To be noted, the method of forming the hollow portion in the frame or temple of the invention includes a step of supplying a gas into the frame or temple, or steps of supplying a liquid during the formation of the frame or temple and removing the liquid to make the hollow portion in the frame or temple. These methods are creative and not complicated, facilitating mass production.

### BRIEF DESCRIPTION OF THE DRAWINGS

FIG. 1 is a schematic diagram of a frame of a lens device according to a preferred embodiment of the invention;

FIGS. 2 to 5 are flow charts of manufacturing methods of a frame of a lens device according to a preferred embodiment of the invention;

FIG. 6 is a schematic diagram of a temple of a lens device according to a preferred embodiment of the invention; and

FIGS. 7 to 10 are flow charts of manufacturing methods of a temple of a lens device according to a preferred embodiment of the invention.

### DETAILED DESCRIPTION OF THE INVENTION

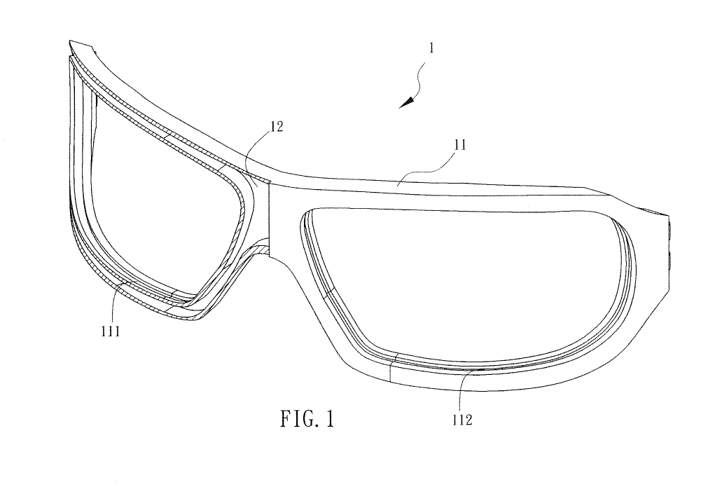

FIG. 1 is a schematic diagram of a frame 1 of a lens device according to a preferred embodiment of the invention. In the invention, the frame 1 is not limited in type, which can be a frame of sunglasses, working goggles, nearsighted eyeglasses, farsighted spectacles, presbyopia eyeglasses, snow goggles, or the like.

As shown in FIG. 1, the frame 1 includes a frame portion 11 and at least a hollow portion 12. The frame portion 11 is used to fix the lens, and therefore it is usually configured with some structure, such as a slot, locking portion or embedding portion. Besides, the shape of the frame portion 11 is often designed according to the number of the lens. For example, if there is only one lens for a lens device covering the range of the two eyes of the user, the slot of the frame portion 11 can be formed from one side of the frame portion 11 to the other side. If there are two lenses for a lens device, the frame portion 11 can have two slots which are respectively corresponding to the two lenses and disposed symmetrically. However, this invention is not limited thereto. In this embodiment, the frame portion 11 has two lens-holding portions 111 and 112 for holding the lenses. The lens-holding portions 111 and 112 each have a closed form here. In other embodiments, the lens-holding portions 111 and 112 can have unclosed forms, according to the actual requirements.

Furthermore, as an embodiment, the configuration of the hollow portion 12 can cause the frame portion 11 to have a wall thickness not less than 0.5 mm, so that the frame 1 maintains sufficient structural strength. However, the invention is not limited thereto.

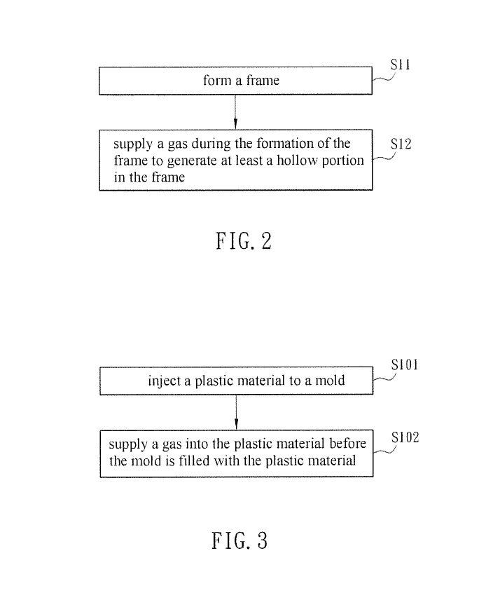

FIG. 2 is a flow chart of a manufacturing method of a frame of a lens device according to a preferred embodiment of the invention, including the steps S11 and S12. As shown in FIGS. 1 and 2, the step S01 is to form a frame 1. This step can be implemented by injection molding, but however, the option of the forming method for the frame 1 can be changed in accordance with the material of the frame 1. The step S12 is to supply a gas during the formation of the frame 1 to generate at least a hollow portion 12 in the frame 1. FIG. 3 is a flow chart of a practical application of the manufacturing method in FIG. 2. As shown in FIG. 3, the step S101 is to inject a plastic material to a mold, and then the step S102 is to supply a gas into the plastic material before the mold is filled with the plastic material. Thereby, the plastic material can be formed into the frame 1 with the hollow portion 12 therein. To be noted, the place of the supplied gas is also the place of the hollow portion, so the place and size of the hollow portion can be determined according to the place and amount of the supplied gas. In this embodiment, the gas can be, for example, carbon dioxide or nitrogen, but this invention is not limited thereto.

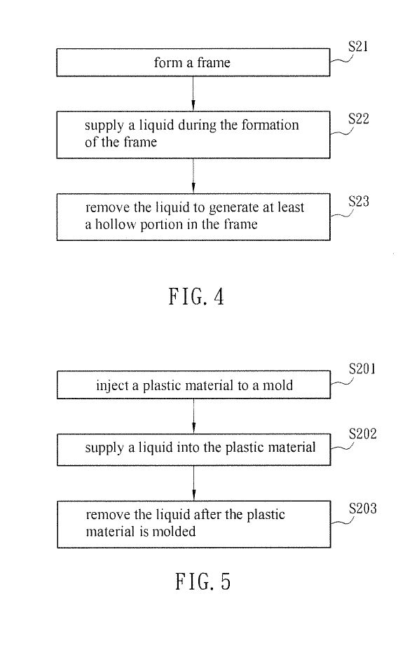

FIG. 4 is a flow chart of another manufacturing method of a frame of a lens device according to a preferred embodiment of the invention, including the steps S21 to S23. As shown in FIGS. 1 and 4, the step S21 is to form a frame 1. This step can be implemented by injection molding, but however, the option of the forming method for the frame 1 can be changed in accordance with the material of the frame 1. The step S22 is to supply a liquid during the formation of the frame 1. The liquid is not limited in kind, and it can be water for example. Preferably, the liquid is without corrosiveness, or will not react with the material of the frame 1. The step S23 is to remove the liquid to generate at least a hollow portion 12 in the frame 1. To be noted, the place of the supplied liquid is also the place of the hollow portion, so the place and size of the hollow portion can be determined according to the place and amount of the supplied liquid. FIG. 5 is a flow chart of a practical application of the manufacturing method in FIG. 4. As shown in FIG. 5, the step S201 is to inject a plastic material to a mold, then the step S202 is to supply a liquid into the plastic material, and then the step S203 is to remove the liquid after the plastic material is molded. Thereby, the frame 1 with the hollow portion 12 therein can be formed.

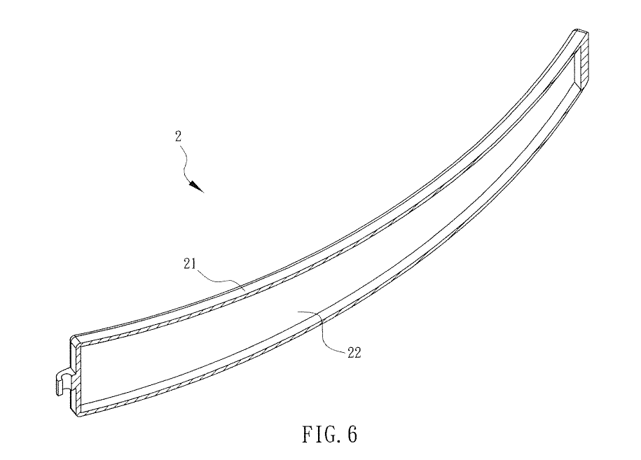

FIG. 6 is a schematic diagram of a temple 2 of a lens device according to a preferred embodiment of the invention. In the invention, the temple 2 is not limited in type, which can be a temple of sunglasses, working goggles, nearsighted eyeglasses, farsighted spectacles, presbyopia eyeglasses, snow goggles, or the like.

As shown in FIGS. 6, the temple 2 includes a temple portion 21 and at least a hollow portion 22. The temple portion 21 is usually put on the user's ears, and to stable the lens device, it usually has some structure, such as a hook or a band-fastening portion for fastening a band of the lens device. However, the invention is not limited thereto. Besides, there are often two temples for a general pair of eyeglasses, and the temples are disposed to the opposite sides of the frame respectively and symmetrically. However, this invention is not limited hereto however.

Furthermore, as an embodiment, the configuration of the hollow portion 22 can cause the temple portion 21 to have a wall thickness not less than 0.5 mm, so that the temple 2 maintains sufficient structural strength. However, the invention is not limited thereto.

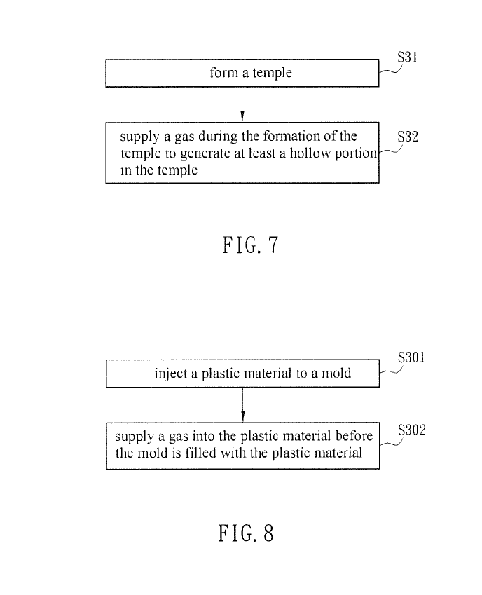

FIG. 7 is a flow chart of a manufacturing method of a temple of a lens device according to a preferred embodiment of the invention, including the steps S31 and S32. As shown in FIGS. 6 and 7, the step S31 is to form a temple 2. This step can be implemented by injection molding, but however, the option of the forming method for the temple 2 can be changed in accordance with the material of the temple 2. The step S32 is to supply a gas during the formation of the temple 2 to generate at least a hollow portion 22 in the temple 2. FIG. 8 is a flow chart of a practical application of the manufacturing method in FIG. 7. As shown in FIG. 3, the step S301 is to inject a plastic material to a mold, and then the step S302 is to supply a gas into the plastic material before the mold is filled with the plastic material. Thereby, the plastic material can be formed into the temple 2 with the hollow portion 22 therein. To be noted, the place of the supplied gas is also the place of the hollow portion, so the place and size of the hollow portion can be determined according to the place and amount of the supplied gas. In this embodiment, the gas is, for example, carbon dioxide or nitrogen, but this invention is not limited thereto.

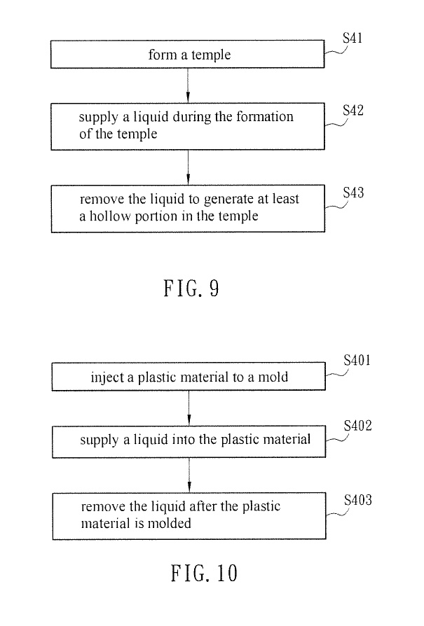

FIG. 9 is a flow chart of another manufacturing method of a temple of a lens device according to a preferred embodiment of the invention, including the steps S41 to S43. As shown in FIGS. 6 and 9, the step S41 is to form a temple 2. This step can be implemented by injection molding, but however, the option of the forming method for the temple 2 can be changed in accordance with the material of the temple 2. The step S42 is to supply a liquid during the formation of the temple 2. The liquid is not limited in kind, and it can be water for example. Preferably, the liquid is without corrosiveness, or will not react with the material of the temple 2. The step S43 is to remove the liquid to generate at least a hollow portion 12 in the temple 2. To be noted, the place of the supplied liquid is also the place of the hollow portion, so the place and size of the hollow portion can be determined according to the place and amount of the supplied liquid. FIG. 10 is a flow chart of a practical application of the manufacturing method in FIG. 9. As shown in FIG. 10, the step S401 is to inject a plastic material to a mold, then the step S402 is to supply a liquid into the plastic material, and then the step S403 is to remove the liquid after the plastic material is molded. Thereby, the temple 2 with the hollow portion 22 therein can be formed.

A lens device according to a preferred embodiment of the invention can include any of the frames as mentioned above and at least one lens. The frame has at least a hollow portion, and the lens is fixed to the frame. The lens device of this embodiment is, for example, sunglasses, working goggles, nearsighted eyeglasses, farsighted spectacles, presbyopia eyeglasses, snow goggles, or the like. Besides, another lens device according to a preferred embodiment of the invention can include a frame, two temples as mentioned above, and at least one lens. The frame can have the hollow portion or not. The temples each have a hollow portion, and are respectively disposed to the opposite sides of the frame. The lens is fixed to the frame.

In summary, at least a hollow portion is formed in the frame and/or temple of the lens device of the invention by several methods, so the frame and temple can be decreased in weight while maintaining sufficient structural strength. Therefore, the user getting used to wear eyeglasses can take less pressure at the wings of the nose, and thereby the using efficiency and product competitiveness can be enhanced a lot. Besides, since the lens device, frame and temple of the invention is lighter, their densities can be controlled as less than 1, i.e. the density of water. Therefore, when the user doing aquatic sports loses the eyeglasses, the user can easily find them. Furthermore, since the lens device, frame and temple of the invention consume less material, the environmental protection can be effectively achieved. To be noted, the method of forming the hollow portion in the frame or temple of the invention includes a step of supplying a gas into the frame or temple, or steps of supplying a liquid during the formation of the frame or temple and of removing the liquid to make the hollow portion in the frame or temple. These methods are creative and not complicated, facilitate to mass production.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A frame of a lens device, comprising:
a frame portion; and
at least a hollow portion disposed in the frame portion.

2. The frame as recited in claim 1, wherein the hollow portion causes the frame portion to have a wall thickness not less than 0.5 mm.

3. A temple of a lens device, comprising:
a temple portion; and
at least a hollow portion disposed in the temple portion.

4. The temple as recited in claim 3, wherein the hollow portion causes the temple portion to have a wall thickness not less than 0.5 mm.

5. A lens device, comprising:
a frame as recited in claim 1; and
at least a lens fixed to the frame.

6. A lens device, comprising:
a frame;
two temples as recited in claim 3, respectively disposed to the opposite sides of the frame; and
at least a lens fixed to the frame.

7. A manufacturing method of a frame of a lens device, comprising steps of:
forming a frame; and
supplying a gas during the formation of the frame to generate at least a hollow portion in the frame.

8. A manufacturing method of a temple of a lens device, comprising steps of:
forming a temple; and
supplying a gas during the formation of the temple to generate at least a hollow portion in the temple.

9. A manufacturing method of a frame of a lens device, comprising steps of:
forming a frame;
supplying a liquid during the formation of the frame; and
removing the liquid to generate at least a hollow portion in the frame.

10. A manufacturing method of a temple of a lens device, comprising steps of:
forming a temple;
supplying a liquid during the formation of the temple; and
removing the liquid to generate at least a hollow portion in the temple.
